(19) United States
(12) Patent Application Publication
(10) Pub. No.: US 2025/0078548 A1
(43) Pub. Date: Mar. 6, 2025

(54) AUTHENTICATION OF AN EVENT THROUGH CERTIFICATION AND VERIFICATION OF A COMPUTER FILE

(71) Applicant: PAEHMS SAS, Lille (FR)

(72) Inventor: Paul TASLE D'HELIAND, Paris (FR)

(21) Appl. No.: 18/721,960

(22) PCT Filed: Dec. 23, 2022
(86) PCT No.: PCT/EP2022/087704

§ 371 Date: Jun. 20, 2024

(30) Foreign Application Priority Data
Dec. 23, 2021 (FR) 2114350

(51) Int. Cl. G06V 20/00; G06V 10/74; H04L 67/52

(52) U.S. Cl. CPC G06V 20/95; G06V 10/74; H04L 67/52; G06V 2201/10

(57) ABSTRACT

The present invention relates to a method for checking an item of multimedia content relating to an event. The method includes capturing an item of multimedia content containing an event using a communication terminal to generate a multimedia file. Metadata generated by the terminal is then retrieved. The multimedia file is processed by assigning the generated metadata to the item of multimedia content to certify the multimedia file. The certified multimedia file is then transmitted to a central server (10). A geolocated notification is sent to the terminals that are located in a given zone close to the event to flag the existence of the certified multimedia file and request verification of the certified multimedia file by validating or invalidating same.

### TECHNICAL FIELD

The present invention relates to the field of systems and methods for capturing multimedia contents intended to be shared and/or published via any type of digital media, in particular on the Internet like for example on social networks.

One of the objects of the present invention is to provide a reliable and robust solution for authenticating events by resorting to computer files such as for example multimedia files.

In the context of the present invention, by multimedia file, it should be understood any computer file containing multimedia-type digital data in the form of video, photo or audio.

Other forms may also be considered.

The present invention also covers the certification and the verification of any computer file that comprises multimedia data and other data such as for example metadata such as for example location data and/or intrinsic and/or extrinsic data relating to the communication terminal and/or to the “data” as such (digital and multimedia data) and is intended to be shared and/or published on a digital medium, in particular on the Internet like for example on social networks or any private or public, closed or open, communication channel.

The present invention will find numerous advantageous applications for all actors intervening in the information sharing and/or broadcasting chain, in particular on the Internet and social networks, and that being so both for information producers including in particular the witnesses of any event to be shared or broadcast such as for example journalists and reports and for the recipients and broadcasters of this information, in particular news agencies and medias for journalists and reporters or for news agencies and medias.

It should be understood that the present invention will also find other advantageous applications in other fields such as for example the field of reference multimedia evidences or the broader security field. Thus, the present invention could also apply to any application requiring the certification and the verification of an event like for example the army, the special forces, firefighters, rescue teams, the event industry, the construction and public works sector, public services, etc.

### PRIOR ART

The Internet, and more generally the new information and communication technologies (also known by the English acronym ICT, standing for “information and communication technologies”) have completely revolutionized access to information these last years.

Thus, the multiplicity of alternate broadcast channels, in particular social networks on websites such as Facebook® or Twitter® and the very many discussion forums and blogs, are nowadays unavoidable media for broadcasting information.

In some countries, alternate broadcast and reception channels, in particular the Internet and social networks, may sometimes be the only media accessible to the population to obtain information that have not undergone censorship.

One could notice that, throughout these new channels, the information becomes viral and propagates in real-time throughout the world.

However, the information that circulate on these alternate broadcast channels, in particular the Internet and these networks, are not always reliable.

It is known that people who publish information on alternate broadcast channels, in particular the Internet and these social networks, often demonstrate an extremely poor judgment.

Unlike professional journalists, whether corporate or independent, the users of alternate broadcast channels, in particular the Internet and social networks are not bound by journalistic ethics: thus, the users of these networks are not bound by an elementary rule that requires verifying the facts, the sources and the information.

Such a journalistic rule is the basis of the work of the journalist.

Considering this absence of any control of the information, it becomes possible nowadays to propagate a huge amount of non-verified information through the alternate broadcast channels, in particular the Internet and these social networks.

For these reasons, we now find on the alternate broadcast channels in particular the Internet and these social networks, information originating from bloggers, media, politicians, and even governments, which might be inaccurate, erroneous, and even completely false.

Thus, we talk about “fake news”.

Broadcasting these fallacious information is intended solely to manipulate or mislead the general public, most often for mercantile, political or ideological purposes.

The broadcast and growth of this “fake news” is of singular importance in the Internet era as the population nowadays no longer search for information from corporate news agencies but directly from alternate networks, in particular the Internet and social networks like Facebook® or Twitter® and some influencers.

Considering the increasing popularity of alternate broadcast channels, in particular social networks, and the growth of these unchecked information, it is essential to be able to control the content of the invention and its origin.

Of course, such a control is even more difficult as these multimedia files circulate in large volumes on these channels and networks and represent an extremely huge volume of data.

Nonetheless, attempts have been made in the prior art to provide solutions intended to address this phenomenon.

In particular, we know about the company Safe Creative® which offers a solution commercialized under the brand SafeStamper® which provides a technology for generating and managing the copyright evidences for digital multimedia files.

This technology of the prior art is described in the documents ES2472272B1, ES2592533B1, ES2624916B1 and ES2659691B1.

The latter comprises the following steps:
recovery and display of the time of production of multimedia content;
recovery and display of the date of production of the multimedia content;
display of the captured multimedia file; and
recovery and display of the location of production of the multimedia content.

Nonetheless, the Applicant states that the solution deployed according to this technology has many drawbacks: the process of validation of the multimedia content is not comprehensive and does not ensure a complete control of the information.

The Applicant further states that this solution does not fully exploit the power offered by the metadata produced by the communication terminal during the production process of the multimedia file.

It only allows certifying the process of production of a file without considering the occurrence of an event.

The document FR3095874A1 is also known which relates to the field of certification of the authentication of multimedia content exchanged throughout a data network between different users.

The solution proposed in this document primarily aims to certify an image of an event acquired using a terminal of a first user by generating an archiving code from the metadata of the image to create a digital fingerprint.

The method suggested in this document FR3095874A1 comprises the following steps:
creation of a first digital image;
activation of a processing of the digital image resulting in the creation of an archiving digital fingerprint;
creation of a second image including a superposition of the first digital fingerprint on the first digital image;
emission of a first message including the second digital image to at least one first recipient by means of a communication interface of the first electronic terminal resulting in the creation of an archiving code
   wherein the emission of the first message to the first recipient simultaneously causes the emission of a second message to a trusted third-party which just stores this message.

No verification of the content of the file is herein possible with this solution.

The document FR3095874A1 provides a complex solution whose robustness is not satisfactory and the information is not verified.

Hence, the Applicant states that, to date, there is no reliable and robust technology allowing authenticating an event by controlling the multimedia files and more generally the computer files.

### SUMMARY OF THE PRESENT INVENTION

The present invention aims to improve the above-described situation.

One object of the present invention is to solve at least one of the problems of the previously-described technological background.

In particular, one of the objectives of the present invention is to overcome the different aforementioned drawbacks by providing a solution for controlling a digital content relating to an event.

According to a first aspect, an object of the present invention relates to a method for controlling at least one digital content such as for example multimedia content relating to an event.

According to the present invention, the method comprises the following steps:
a) capturing a digital content, such as for example multimedia content containing an event, using a communication terminal (we also talk about a production terminal) to generate a computer file, so-called the multimedia file;
b) recovering metadata generated by the communication terminal during the capture step;
c) processing the file (for example a multimedia file) by assigning the generated metadata to the digital content (for example the multimedia content) to create a digital fingerprint configured in order to certify the digital file (for example the multimedia file);
d) transmitting the certified digital file by said digital fingerprint to a central server;
e) emitting by the central server a geolocated notification to at least one local computer entity to require before the at least one local computer entity a verification of the certified multimedia file through a validation of the digital content of the certified multimedia file.

In one embodiment, during the emission step, it is provided to emit a notification to at least one local server. It should herein be understood that this consists of a server that could comprise local data associated with said event. Such a server may be installed anywhere. It is primarily characterized by the local data that it is likely to store.

In this embodiment, during the verification step, the validation of the digital content of the certified multimedia file comprises a comparison of said digital content with local data stored by the local server.

Preferably, the digital content comprising images relating to said event.

Preferably, the comparison implements image processing algorithms to compare the local data and said images.

Preferably, the local data stored by said at least one local server are of the GEOINT (standing for “GEOspatial intelligence”) or OSINT (standing for “Open Source Intelligence”) type.

In another embodiment which may be combined with the previous embodiment, during the emission step, it is provided to emit a geolocated notification to all communication terminals located within a determined area proximate to said event.

Advantageously, the verification step comprises:
a visualization by a user of the digital content on an interface of one of the communication terminals located within the determined area proximate to said event;
an interaction of said user with the communication terminal to validate said digital content if the latter is in accordance with the event perceived by said user on said area.

Thus, this verification by third-parties is in the form of a validation (or invalidation) of the latter, for example via a human-machine interface (a GUI-type graphical interface for example). Thus, each third-party can visualize on his/her terminal the content of the file and validate its content for example by checking the box “file verified” or “file valid”.

Thus, the present invention enables the other witnesses of an event to validate or invalidate the content of a multimedia file produced during the event. This validation/invalidation may be done according to various forms for example using a “yes/no” type survey.

Thanks to the combination of the technical steps, features of the present invention, it becomes possible to simply control multimedia content circulating on the Internet by exploiting the metadata of the communication terminal associated with capturing of the multimedia content.

Advantageously, the notification emitted by the central server comprises a request for capturing another digital content relating to the same event.

Thus, the present invention allows confirming a first produced file with other produced files relating to the same event. In this case, this verification therefore comprises a comparison of the content of the first file with the content of at least one other second file. For example, this comparison could comprise image processing algorithms intended to compare the images of the same event to determine similarities (colorimetry, movement detection, shape recognition, etc.) therein.

An automated comparison, using for example computer vision (“computer vision”) type artificial intelligence algorithms, of the content with the GEOINT and OSINT data which does not necessarily involve any human intervention, except for the interpretation of the result of said automated comparison enabled by the local servers.

Advantageously, following this request, at least one of the third-party communication terminals located in the area captures another digital content containing the event and generates a third-party multimedia file which then undergoes the above-described steps b), c) and d) so that said central server recovers at least one certified third-party multimedia file.

Advantageously, the central server associates the at least one certified third-party multimedia file with the certified multimedia file to create a verified multimedia file accessible to all communication terminals (also so-called consultation terminals) connecting to the central server.

Thus, the present invention allows encapsulating, for the same event, all of the produced files relating to this same event. This encapsulation ensures a good reliability of the files of the same event.

Advantageously, the method according to the present invention comprises a creation of another verified multimedia file relating to the same event by at least one other set of communication terminals.

Advantageously, the verified multimedia file and the at least one other verified multimedia file are recorded on the central server.

Advantageously, the metadata of the certified multimedia files and of the certified third-party multimedia files present in the verified multimedia file and the at least one other verified multimedia file are compared with each other.

For example, such a comparison is implemented by a dedicated comparison algorithm implemented on said central server, preferably in an automatic manner.

For example, such an algorithm may also implement “Machine Learning” type learning methods.

In case of similarity between the metadata upon this comparison, the method according to the present invention comprises a creation of an authenticated event associating the verified multimedia file and the at least one other verified multimedia file, said authenticated event being accessible to all communication terminals (herein so-called consultation terminals) connecting to the server.

It should herein be understood that this creation of an authenticated event is done automatically using a dedicated algorithm.

Advantageously, the central server generates, according to the information relating to the location of the event contained in the metadata, an interactive map, an automatically generated video and/or a 3D rendering of the event allowing consulting all of the certified multimedia files of a verified multimedia file or of an authenticated multimedia file.

Thus, the present invention allows referencing the produced files on an interactive map and/or a video and/or a 3D rendering made available to all of the users of the system.

Advantageously, the metadata comprise a piece of information relating at least to: a time, a date, a location, an altitude, a movement, a path followed, a speed of movement, an orientation of the point of view, a nature of the content such as for example audio, photo or video, a capture duration, a communication terminal type (the model, the serial number, the reference, etc.), an author, a legend.

Advantageously, the area is determined by a separation distance relative to said event or to the communication terminal comprised between 0 and 100 meters, preferably substantially equal to 50 meters.

Advantageously, the method according to the present invention comprises an analysis of the multimedia content and in particular of the images and/or sounds contained (objects, shapes, colors, luminosity, background noise) in the multimedia file to generate from this analysis a digital fingerprint associated with this content. This digital fingerprint represents a real identity card of the multimedia content.

Preferably, this digital fingerprint is then associated with said certificate.

Thus, the certificate becomes non-fungible.

In an advantageous embodiment, the certificate and the digital fingerprint may be stored on a blockchain-type server.

Correlatively, an object of the present invention relates, according to a second aspect, to a system for controlling a digital content such as for example multimedia content relating to an event, said system comprising at least one communication terminal and a management server, wherein said communication terminal comprises:
a capture unit (video camera, photo camera, voice recorder or others) configured to capture a digital content such as for example multimedia content containing an event; and
a processing unit configured to generate a computer file, so-called multimedia file.

Advantageously, the processing unit is configured to recover metadata generated by the communication terminal during the capture and to process the computer file (for example a multimedia file) by assigning the generated metadata to the multimedia content in order to certify the multimedia file; and
Advantageously, the communication terminal comprises communication means configured to transmit the certified multimedia file to the central server.

Advantageously, the central server is configured, after reception of the certified multimedia file, to emit a geolocated notification to all communication terminals located within a determined area proximate to the event to signal the existence of the certified multimedia file and to request before each of the communication terminals of this area a verification of the certified multimedia file through validation or invalidation of the latter.

Advantageously, the system according to the present invention comprises computer means configured for an implementation of the steps of the method as described hereinabove.

According to a third aspect, an object of the present invention relates to a computer program which includes instructions adapted for the execution of the steps of the method according to the first aspect of the present invention, in particular when the computer program is executed by at least one processor.

Such a computer program may use any programming language, and be in the form of a source code, an object code, or an intermediate code between a source code and an object code, such as in a partially-compiled form, or in any other desirable form.

According to a fourth aspect, an object of the present invention relates to a computer-readable recording medium on which a computer program is recorded comprising instructions for the execution of the steps of the method according to the first aspect of the present invention.

On the one hand, the recording medium may consist of any entity or device capable of storing the program. For example, the medium may include a storage means, such as a ROM memory, a CD-ROM or a ROM memory of the microelectronic circuit type, or a magnetic recording means or a hard disk.

On the other hand, this recording medium may also consist of a transmissible medium such as an electrical or optical signal, such a signal could be routed via an electrical or optical cable, by conventional radiofrequency or hertzian waves or by a self-steering laser beam or by other means. In particular, the computer program according to the present invention may be downloaded on an Internet-type network.

Alternatively, the recording medium may be an integrated circuit in which the computer program is incorporated, the integrated circuit being adapted to execute or to be used in the execution of the considered method.

Thus, thanks to its different functional and structural aspects described hereinabove, the object of the present invention allows authenticating the occurrence of one or more event(s) by confirmation of multimedia contents relating to this or these same event(s), certified using metadata generated by the production terminal at the origin of the content(s) and a verification of the content(s) through validation or invalidation by the third-party terminals located in the area proximate to said event.

### BRIEF DESCRIPTION OF THE FIGURES

Other features and advantages of the present invention will appear from the description of the particular and non-limiting embodiments of the present invention hereinafter, with reference to the appended FIGS. 1 to 17, wherein:

FIG. 1 shows a schematic view of the architecture of a system for controlling multimedia content relating to an event according to an embodiment of the present invention;

FIG. 2 shows another detailed schematic view of the architecture of a system in accordance with FIG. 1 for certification of a multimedia file.

FIG. 3 shows a flowchart of the different steps of a method implemented by a system in accordance with FIG. 1 or 2.

FIG. 4 shows an illustration of the implementation of a step of the steps of the method according to FIG. 3;

FIG. 5 shows an illustration of the implementation of one of the steps of the method according to FIG. 3;

FIG. 6 shows an illustration of the implementation of one of the steps of the method according to FIG. 3;

FIG. 7 shows an illustration of the implementation of one of the steps of the method according to FIG. 3;

FIG. 8 shows an illustration of the implementation of one of the steps of the method according to FIG. 3;

FIG. 9 shows an illustration of the implementation of one of the steps of the method according to FIG. 3;

FIG. 10 shows an illustration of the implementation of one of the steps of the method according to claim 3;

FIG. 11 shows an illustration of the implementation of one of the steps of the method according to claim 3;

FIG. 12 shows an illustration of the implementation of one of the steps of the method according to claim 3;

FIG. 13 shows an illustration of the implementation of one of the steps of the method according to claim 3;

FIG. 14 shows an illustration of the implementation of one of the steps of the method according to claim 3;

FIG. 15 shows an illustration of the implementation of one of the steps of the method according to FIG. 3;

FIG. 16 shows an illustration of the implementation of all of the steps of the method according to FIG. 3 enabling a plurality of communication terminals to consult a controlled multimedia content; and

FIG. 17 shows a schematic view of a system for controlling multimedia content relating to an event according to an embodiment of the present invention in accordance with FIG. 1 or 2.

### DETAILED DESCRIPTION

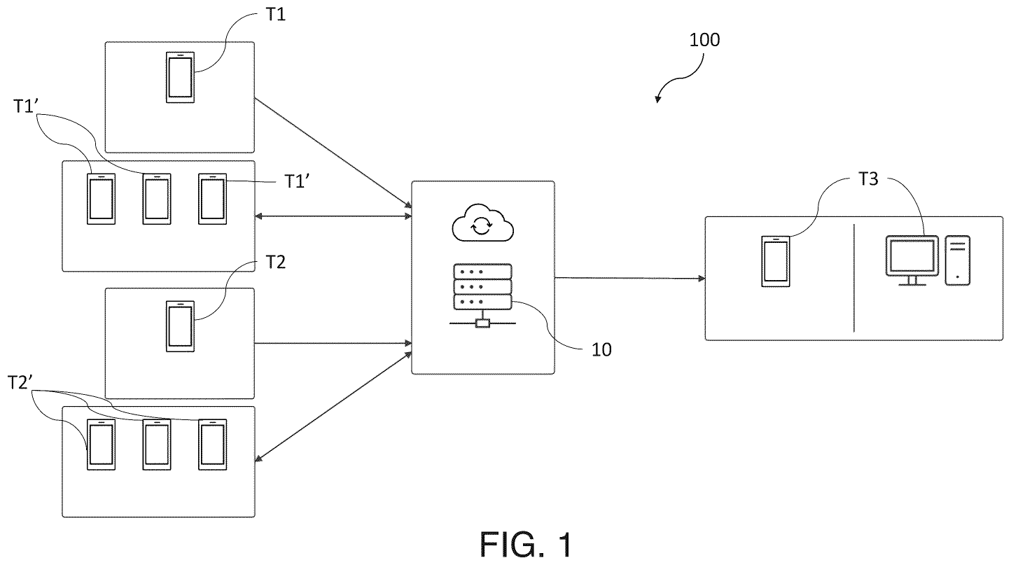

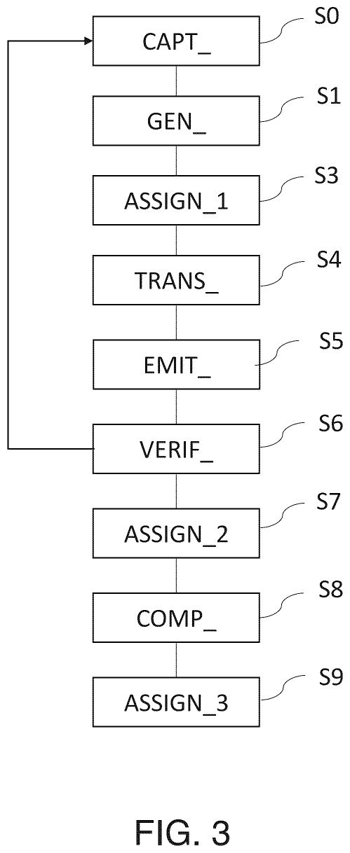

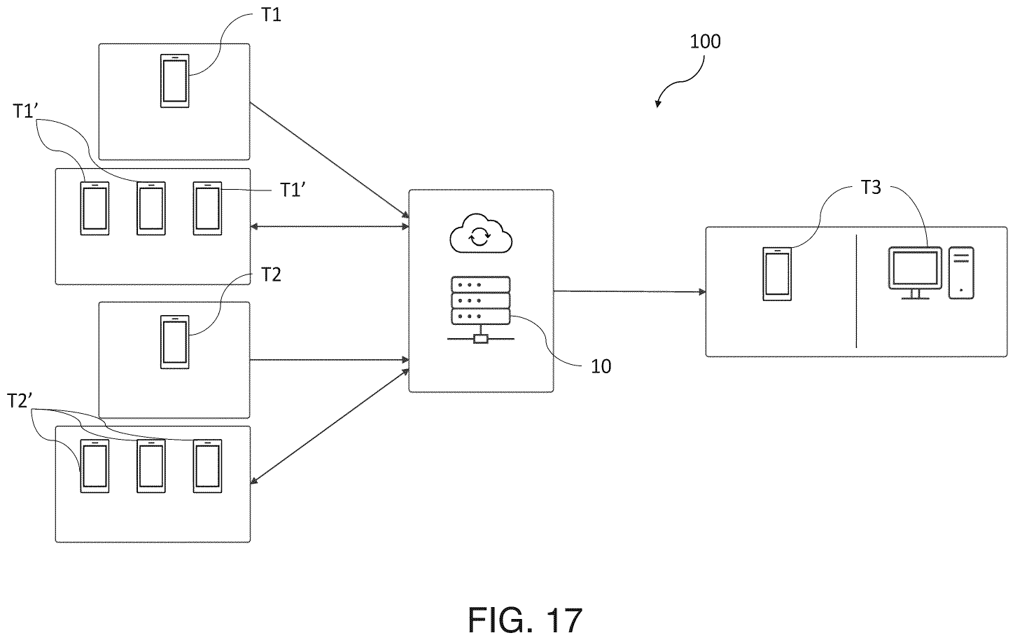

A control system 100 as well as the method associated therewith will now be described hereinafter with reference to FIGS. 1 to 17 together.

The same elements are identified with the same reference signs throughout the following description.

As explained in the preamble, the high volumes of information flows circulating on alternate broadcast channels, in particular the Internet and the different social networks, has promoted the apparition of fallacious information.

The present invention aims to overcome this problem by providing a new approach for authenticating multimedia content.

The present invention achieves this objective in the following example.

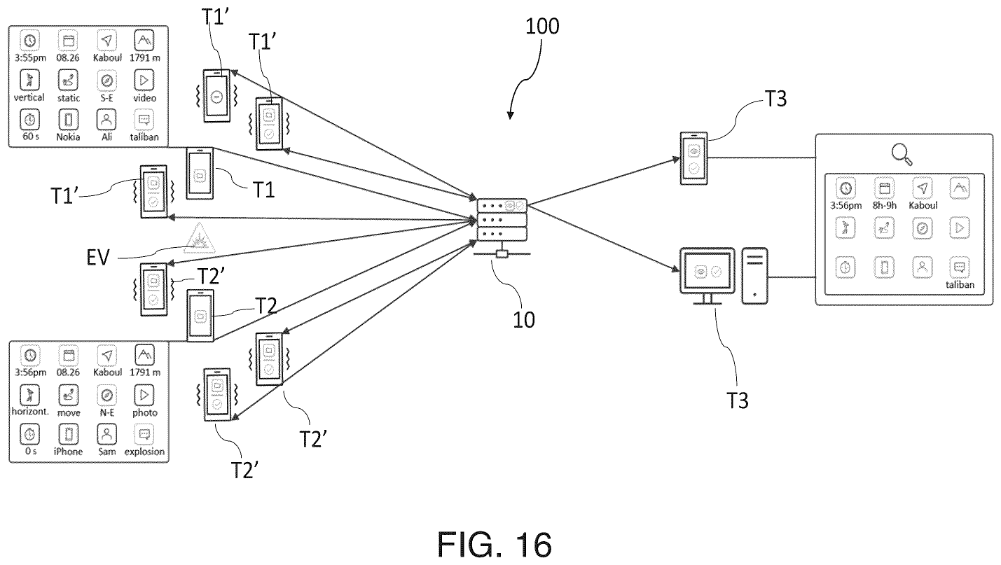

In this example and as illustrated in FIG. 16, we consider the fictional situation of an event EV such as for example an explosion in Kabul airport that happened on Aug. 26, 2021 around 3:50 PM.

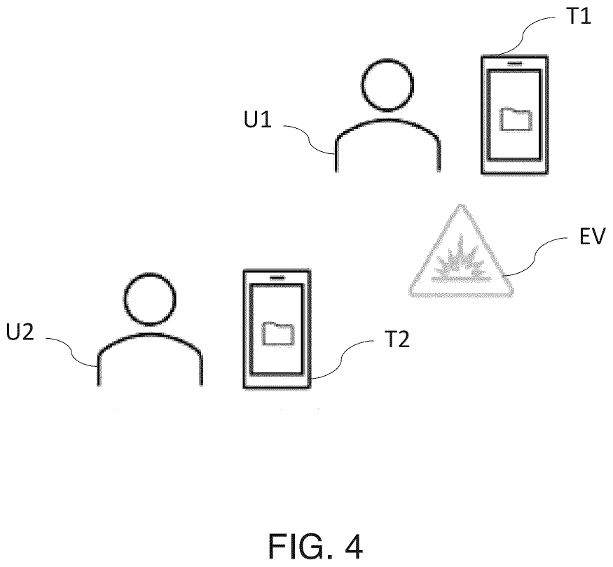

In this example and as illustrated in FIG. 4, a witness U1, herein so-called the user, has a communication terminal T1 equipped with a capture unit 21 such as for example a camera.

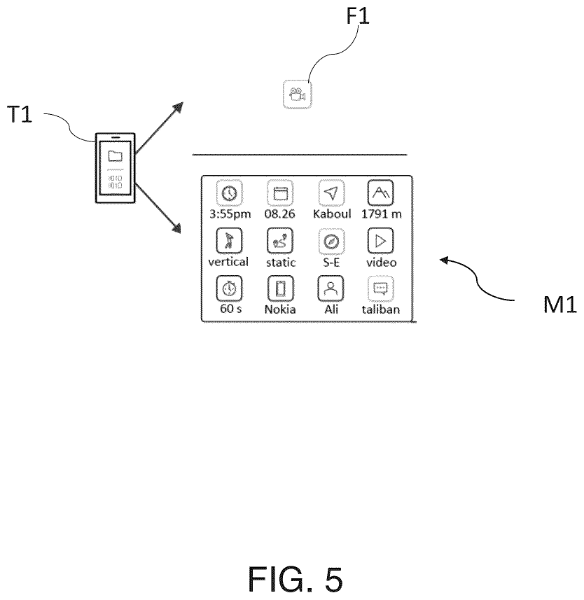

During a capturing step S0 illustrated in FIG. 5, the user U1 captures a scene relating to this explosion EV with the camera 21 of his/her terminal T1.

In this example, the user U1 therefore films this explosion EV at 3:55 PM for 60 seconds.

In this example and as illustrated in FIG. 5, the communication terminal T1 of the user U1 generates during a step S1 a multimedia file F1 comprising the multimedia content, herein a film, relating to this explosion EV.

One of the underlying concepts of the present invention for controlling the veracity of the captured multimedia content consists in exploiting the metadata that are generated by the communication terminal having captured the multimedia content.

It should herein be noted that the capture unit 21 may also be dissociated from the communication terminal as such. It may consist of a production terminal (video camera, photo camera, voice recorder or others) structurally independent of the terminal and directly or indirectly connected to the latter by wired or wireless means enabling pairing between the communication terminal and the capture unit.

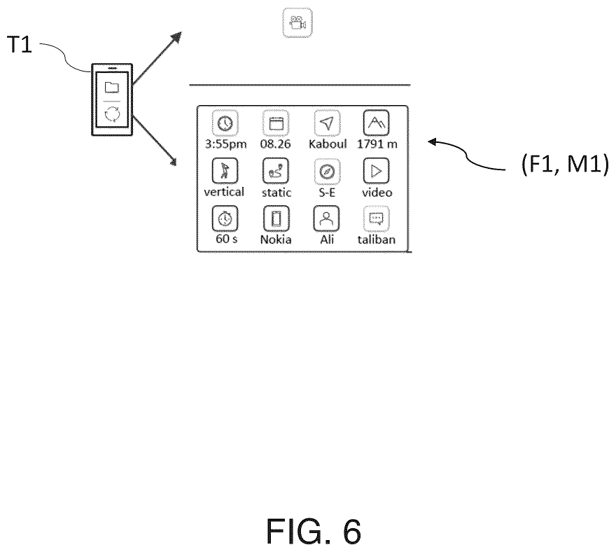

In this example, the communication terminal T1 comprises a processing unit 22 implementing a processing algorithm configured to recover the metadata M1 generated by the terminal T1 during this capture S0 (FIG. 6).

These metadata M1 describe a plurality of information relating to the multimedia content itself or the communication terminal having been used for capturing the latter. These metadata characterize the captured multimedia content and therefore comprise information on the source of the multimedia content (title, author, date, time, capture duration, terminal type, terminal model, etc.), the nature of the multimedia content (video, photo, audio, etc.), its information content (descriptors, keywords, summary) and its physical location (position and GPS coordinates, altitude, movement, path followed, speed of movement, an orientation of the point of view, etc.). Still other information may also be contained in these metadata.

In this example, these metadata M1 comprise the following information (location: Kabul; date: Aug. 26, 2021; time: 3:55 PM; altitude: 1,791 meters, orientation: vertical; kinematics: immobile; position: South-East; type: video; duration: 60 seconds; owner: Ali; keyword: Taliban; etc.).

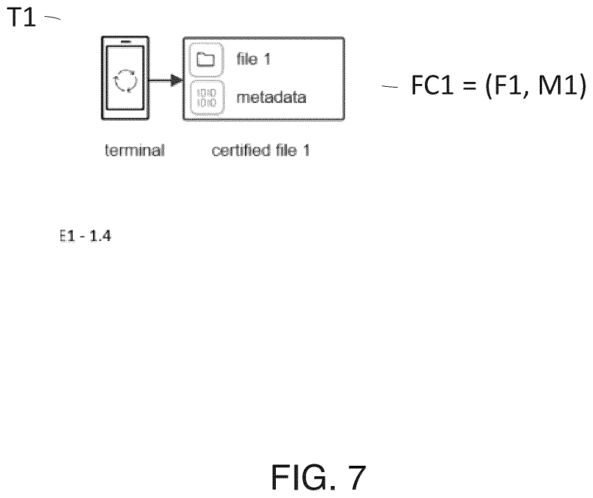

In this example, the processing algorithm of said unit 22 therefore processes said multimedia file F1 during a step S3 by assigning to the file F1 (herein the file containing the video film of the explosion captured by the terminal T1) the metadata M1 generated by the terminal T1 during the capture S0 to certify the file F1 and thus obtain a certified file FC1 (FIG. 7).

This certification of a file F1 containing multimedia content by the metadata M1 produced by the communication terminal T1 having captured the multimedia content is characteristic of the present invention.

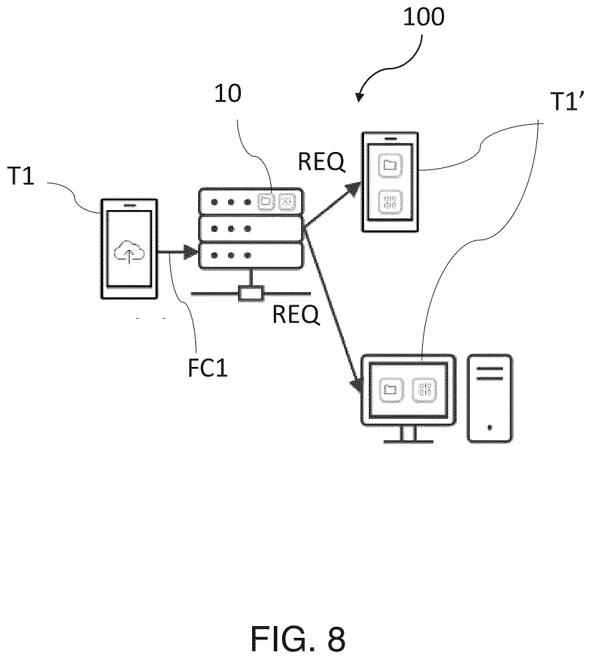

In this example and as illustrated in FIG. 8, the certified file FC1 is then transmitted during a step S4 to a central server 10, which is a remote server such as a server on the cloud or “cloud” servers.

It should herein be understood that the communication terminal T1 therefore comprises communication means 23 able to communicate with the central server 10. Such means are conventional using for example a mobile network such as a 4G (or LTE Advanced according to 3GPP release 10-version 10) or 5G network.

In this example, the certified file FC1 is therefore received by the central server 10 via a dedicated communication interface 12 and recorded on a memory 11.

For example, such a memory 11 corresponds to a volatile and/or non-volatile memory and/or a memory storage device which may comprise the volatile and/or non-volatile memory, such as EEPROM, ROM, PROM, RAM, DRAM, SRAM, flash, magnetic or optical disk.

After reception of said certified multimedia file FC1 and recording of the latter on the memory 11, the server 10 comprises a processor 13 which commands the interface 12 (emission means) to emit during a step S5 a geolocated notification REQ to all communication terminals T1′ located in a determined area proximate to the explosion EV (for example within a 50 meter radius around the terminal T1).

Such a notification REQ is intended to signal the existence of the certified multimedia file FC1 to all terminals T1′ proximate to the terminal T1 and to require before each of these terminals T1′ a verification S6 of said certified multimedia file FC1 by validation or invalidation of the latter.

In this example, the notification REQ therefore allows alerting all terminals T1′ located within a 50 meter radius around the terminal T1 that multimedia content (herein a film) has been published and that these terminals T1′ are requested to verify this content.

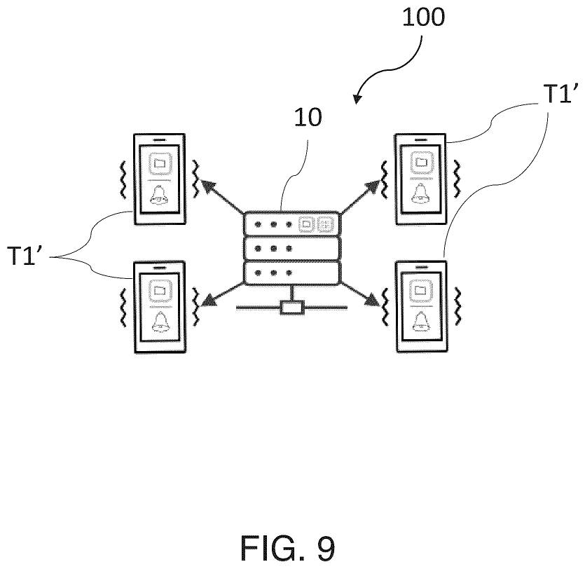

The consultation of this notification REQ enables each user present proximate to the location of publication of the certified file FC1 to consult the latter (FIG. 9) on the interface of his/her terminal T1′ and to validate, or not, the content during the verification step S6.

In this example, it is for example possible to provide for two icons, one for validation and the other for invalidation, on the interface of the dedicated application installed on each terminal T1′.

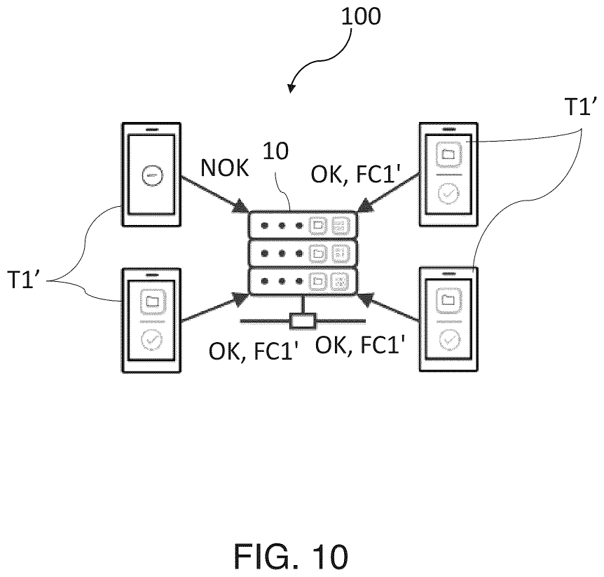

As illustrated in FIG. 10, the third-party users could therefore validate (OK) or invalidate (NOK) multimedia content through a simple interaction with the interface.

This notification REQ also contains an invitation to produce afterwards a third-party certified file FC1′ relating to the same event EV under the same conditions as the certified file FC1.

Each terminal T1′ then replicates the same steps as those described before to, in turn, capture multimedia content, associate the latter with the metadata to certify the captured content and then transmit the third-party certified file FC1′ to the central server 10.

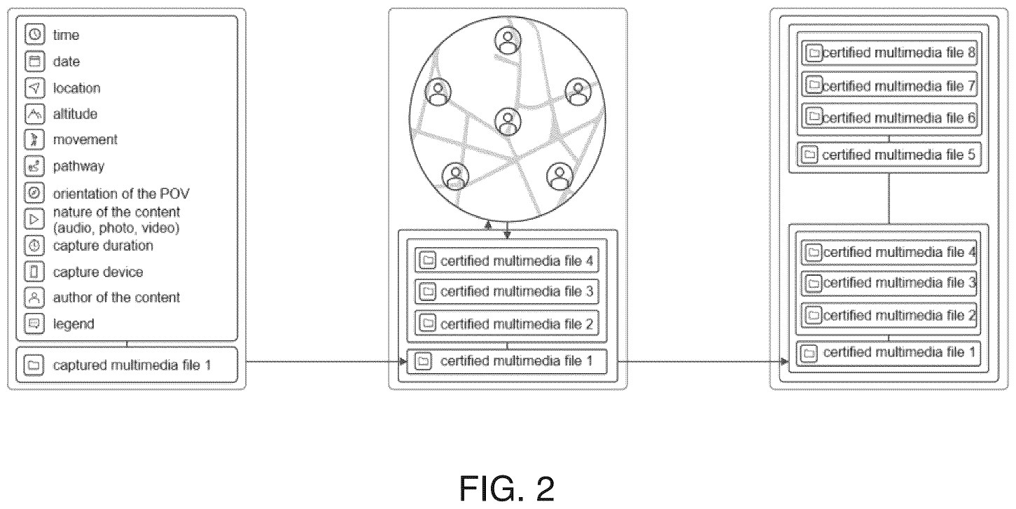

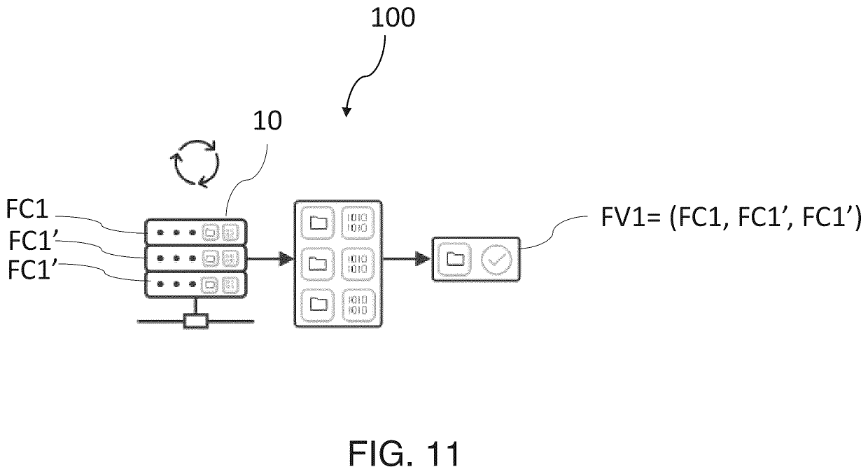

In this example and as illustrated in FIG. 2 or 11, the memory 11 of the server 10 stores all of the third-party certified files FC1′ produced by the terminals T1′ and the certified file FC1 produced by the terminal T1.

Still as illustrated in particular in FIG. 11, the processor 13 then implements a processing algorithm configured to associate, during a step S7, the different third-party certified files FC1′ with the certified file FC1 in a verified file FV1.

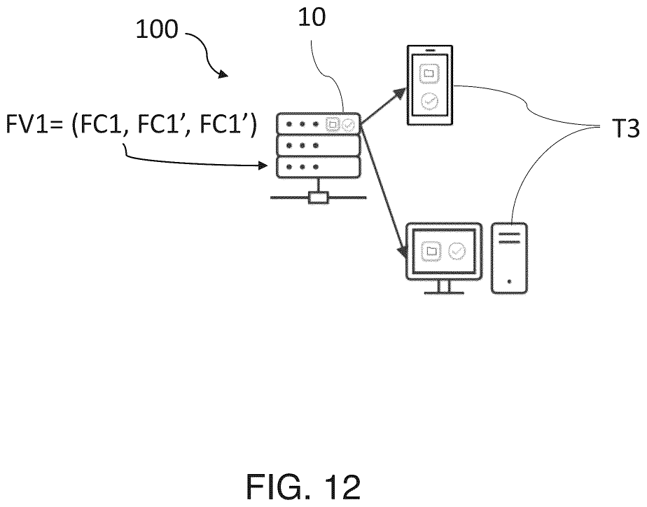

Thus, as illustrated in FIG. 12, the verified file FV1 in which the certified file FC1 and the different third-party certified files FC1′ produced by the users of the system present proximate to the location of publication of the certified file FC1 are associated, after the process of verification by the geolocated notification REQ, is recorded in the memory 11 of the server 10 and is made consultable by all of the other users of the system 100 who are equipped with a communication terminal T3 and who have access to the server 10.

One of the objectives of the present invention is to be able to authenticate an event EV with several verified files.

In this example, another set of users, including a user U2 provided with another terminal T2, is therefore provided for as illustrated in FIGS. 4 and 16.

In the example described herein, this user U2 has also witnessed the explosion EV in Kabul.

In this example, the user U2 takes a photograph of the scene at 3:56 PM.

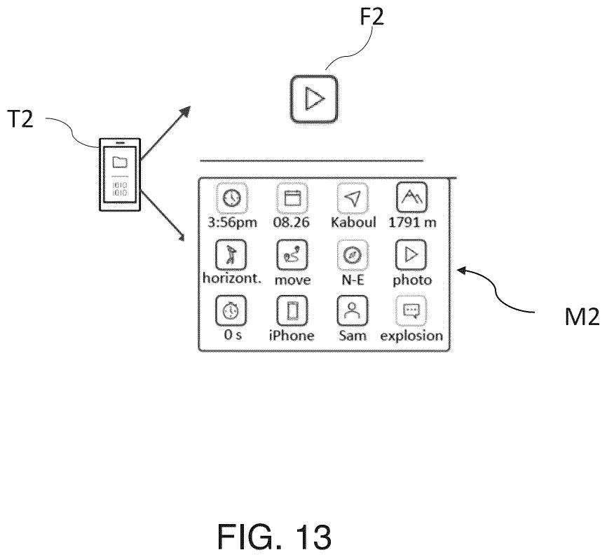

As illustrated in FIG. 13, the communication terminal T2 of the user U2 generates a multimedia file F2 comprising a photo relating to this explosion EV.

If the user U2 witnesses the same explosion EV as the user U1 and if the conditions are substantially identical (Kabul, time of the event, altitude); some of the metadata are different.

In this example, it should be noted that:
the users U1 and U2 have different points of view (POV, standing for “point of view”) relative to the explosion: the user U1 is located in the South-East and the user U2 is located in the North-East;
the user U1 is immobile whereas the user U2 is moving.

The multimedia file F2 produced by the terminal T2 then undergoes all of the steps described before for the multimedia file F1 to be certified in order to generate a certified file FC2.

Thus, as described before and as illustrated in FIG. 16, the certified file FC2 is also transmitted to the central server 10 which emits a geolocated notification to all other terminals T2′ located proximate to the terminal T2 to generate other certified third-party files FC2′ produced by the terminals T2′.

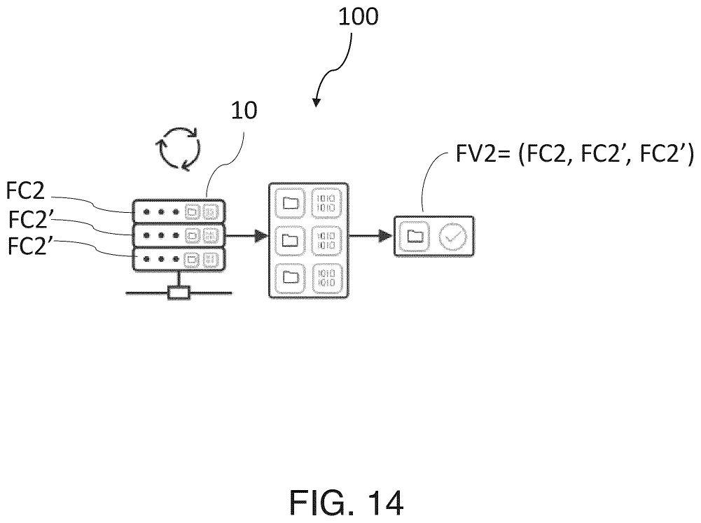

In this example and as illustrated in FIG. 14, at the end of the process, the server 10 then generates another verified file FV2 containing all of the third-party certified files FC2′ produced by the terminals T2′ and the certified file FC2 produced by the terminal T2.

The verified files FV1 and FV2 are then recorded on the server 10 and are made consultable by all of the other users of the system 100.

In this example, the processor 13 of the server 10 comprises a processing algorithm which is configured to formulate the request for analyzing and comparing during a step S8 the metadata (M1, M2) (timestamp, location, altitude, movement, path followed, speed of movement, orientation of the point of view, nature of the multimedia content, capture duration, terminal used for capturing, author of the file, legend) of the certified files (FC1, FC2) and of the third-party certified files (FC1′, FC2′) present in all of the verified files FV1 and FV2.

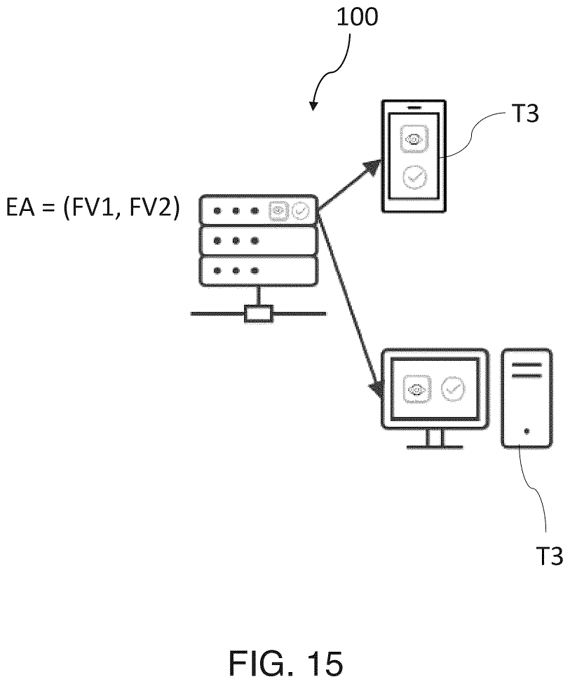

In case of similarity between the metadata (timestamp, location, orientation of the point of view, legend) of the certified files (FC1, FC2) and of the third-party certified files (FC1′, FC2′) present in the verified files (FV1, FV2), the algorithm formulates the request for associating, during a step S9, the verified files FV1 and FV2 into authenticated event EA (FIG. 15).

The authenticated event EA in which the verified files FV1 and FV2 are associated, after the positive result of the analysis and comparison of the metadata having resulted in a similarity between the verified files, is recorded in the server 10, making it consultable by all of the other users of the system 100.

Thus, at the end of the process, we have a plurality of multimedia files all containing contents that have been subjected to certification and strong verification and which allow authenticating an event.

Thus, the present invention offers significant advantages to of the actors of the editorial chain from the reporter on site to the news agency throughout the media.

Thanks to the present invention, the reporter no longer has to precisely describe the content of his/her file (date, time, location, etc.) since the certified file contains the metadata of the communication terminal.

Media no longer have to spend time searching for contents on social networks or contents of freelance journalists, or describing again the context in which the received contents have been captured.

The approach proposed in the context of the present invention and allowing certifying the contents through an upstream validation allows significantly reducing the work, often laborious, of journalists who should systematically verify the veracity of each received multimedia content.

This significantly facilitates this work and limits taking risks in publishing contents that are poorly verified or losing time in the process of referencing the received contents.

Finally, for news agencies, the present invention significantly limits the time loss related:
to searches for contents on social networks or freelance journalist contents;
to the description of the context of capture of the received contents;
to the approximate verification of the received contents;
to the process of referencing the received contents

The present invention also limits taking risk in publishing contents that are poorly verified.

Finally, the Applicant states that the present invention could be applied in any other profession, including journalism. In fine, the present invention aims to produce almost forgery-proof multimedia evidences (video, photo, audio), and more generally to reference the information (whether this consists of journalist information or not).

Thus, it is possible to consider that the present invention finds a broader application in the security field and could be used for example by technicians on the field of an airport or a highway, firefighters or law-enforcement forces, helping them reference, in a smart way, information that might cause damage to goods or persons.

It should be observed that this detailed description covers a particular embodiment of the present invention, but, in any case does this description limit the object of the invention; quite the contrary, it is intended to suppress any inaccuracy or any poor interpretation of the following claims.

It should also be observed that the reference signs placed between brackets in the following claims in no case have a limiting nature; these signs are merely intended to improve the intelligibility and the understanding of the following claims as well as the sought scope of protection.

1. A method for controlling a digital content relating to an event, said method comprising the following steps:
a) capturing a digital content relating to an event using a communication terminal to generate a computer file, so-called the multimedia file;
b) recovering metadata generated by said communication terminal during said capture;
c) processing said multimedia file by assigning said generated metadata to said digital content to create a digital fingerprint configured in order to certify said multimedia file;
d) transmitting said certified multimedia file by said digital fingerprint to a central server;
e) emitting by said central server a geolocated notification to at least one local computer entity to require before said at least one local computer entity a verification of said certified multimedia file through a validation of the digital content of said certified multimedia file.

2. The method according to claim 1, wherein, during the emitting step, the geolocation notification is emitted to at least one local server.

3. The method according to claim 2, further comprising a verification step, where a validation of the digital content of said certified multimedia file comprises a comparison of said digital content with local data stored by said at least one local server.

4. The method according to claim 3, the digital content comprising images relating to said event, wherein the comparison implements image processing algorithms to compare the local data and said digital content.

5. The method according to claim 4, wherein the local data stored by said at least one local server are of the GEOINT and/or OSINT type.

6. The method according to claim 1, wherein, during the emitting step, the geolocated notification is emitted to all communication terminals located within a determined area proximate to said event.

7. The method according to claim 6, wherein the verification step comprises:
a visualization by a user of the digital content on an interface of one of the communication terminals located within the determined area proximate to said event; and
an interaction of said user with said communication terminal to validate said digital content if the digital content is in accordance with the event perceived by said user on said area.

8. The method according to claim 7, wherein said geolocated notification comprises a request before the communication terminals located in the determined area proximate to said event to capture another digital content containing said event.

9. The method according to claim 8, wherein, upon reception of said request, at least one of the communication terminals located in said area captures another digital content containing said event and generates a third-party multimedia file which then undergoes steps b), c) and d) of said method so that said central server recovers at least one certified third-party multimedia file.

10. The method according to claim 9, wherein the central server associates said at least one certified third-party multimedia file with said certified multimedia file to create a verified multimedia file accessible to all communication terminals connecting to said central server.

11. The method according to claim 10, further comprising a creation by at least one other set of communication terminals of at least one other verified multimedia file relating to the same event.

12. The method according to claim 11, wherein said verified multimedia file and said at least one other verified multimedia file are recorded on said central server.

13. The method according to claim 12, wherein the generated metadata of the certified multimedia files and of the certified third-party multimedia files present in the verified multimedia file and said at least one other verified multimedia file are compared with each other.

14. The method according to claim 13, further comprises, in case of similarity between the metadata, a creation of an authenticated event associating the verified multimedia file and said at least one other verified multimedia file, said authenticated event being accessible to all communication terminals connecting to said central server.

15. The method according to claim 11, wherein said central server generates, according to the information relating to the location of said event contained in the metadata, an interactive map, an automatically generated video or a 3D rendering of the event allowing consulting the certified multimedia files, the verified multimedia file and/or the authenticated event.

16. The method according to claim 1, wherein said generated metadata comprises a piece of information relating at least to one selected from a group consisting of: a time, a date, a location, an altitude, a movement, a path followed, a speed of movement, an orientation of the point of view, a nature of the content such as for example audio, photo or video, a capture duration, a communication terminal type, an author, and a legend.

17. The method according to claim 1, wherein an area is determined by a separation distance relative to said event comprised between 0 and 100 meters, preferably substantially equal to 50 meters.

18. A computer program including instructions for an implementation of the method according to claim 1 when said instructions are executed by a processor.

19. A non-transitory computer-readable recording medium on which a computer program is recorded comprising instructions for the execution of the steps of the method according to claim 1.

20. A system for controlling a digital content relating to an event, said system having at least one communication terminal and a management server, wherein said communication terminal comprises:
a camera configured to capture a digital content containing an event;
a processing unit configured to generate a computer file, so-called multimedia file;
said processing unit being configured to recover metadata generated by said communication terminal during said capture and to process said multimedia file by assigning said generated metadata to said multimedia content to create a digital fingerprint in order to certify said multimedia file; and
communication means configured to transmit the certified multimedia file to said central server;
wherein said central server is configured, after reception of said certified multimedia file, to emit a geolocated notification to at least one local computer entity to request before said at least one local computer entity a verification of said certified multimedia file through a validation of the digital content of said certified multimedia file.

21. (canceled)
